(19) United States
(12) Patent Application Publication
(10) Pub. No.: US 2018/0027195 A1
(43) Pub. Date: Jan. 25, 2018

(54) IMAGE PROCESSING APPARATUS AND A CONTROL METHOD FOR CONTROLLING THE IMAGE PROCESSING APPARATUS

(71) Applicant: CANON KABUSHIKI KAISHA, Tokyo (JP)

(72) Inventor: Yohei Yamanaka, Yokohama-shi (JP)

(21) Appl. No.: 15/653,074

(22) Filed: Jul. 18, 2017

(30) Foreign Application Priority Data
Jul. 21, 2016 (JP) 2016-143696

(51) Int. Cl. H04N 5/359; G06T 3/40; H04N 13/02; H04N 5/357; H04N 5/341

(52) U.S. Cl. CPC H04N 5/3597; H04N 5/3572; H04N 5/3415; H04N 13/0217; G06T 3/4015

(57) ABSTRACT

An image processing apparatus includes an image obtaining unit configured to obtain a plurality of viewpoint images, a detecting unit configured to detect a first undesirable component of the viewpoint images according to relative difference information that is a difference between the viewpoint images, a noise information obtaining unit configured to obtain noise information of the viewpoint images, a calculation unit configured to calculate a second undesirable component by subtracting noise from the first undesirable component according to the first undesirable component and the noise information, and a reducing unit configured to reduce the second undesirable component of an image formed based on the viewpoint images.

### BACKGROUND

### Field of the Disclosure

The present disclosure relates to an image processing method for improving the image quality of a captured image.

### Description of the Related Art

When an image capture apparatus such as a camera captures an image, a part of the light entering the optical system is sometimes reflected on the boundary face of a lens or on a member holding the lens and reaches the image pickup plane as an undesirable light. The undesirable light that has reached the image pickup plane appears in the captured image as an undesirable component such as a ghost or flare. Japanese Patent Laid-Open No. 2011-205531 discloses a method that detects a ghost by comparing a plurality of viewpoint images.

The method of Japanese Patent Laid-Open No. 2011-205531 detects a ghost by calculating the difference between the viewpoint images. When each viewpoint image has a large amount of noise, the accuracy of the detection of a ghost is decreased.

### SUMMARY

What is needed is an improvement to provide an image processing apparatus capable of suppressing the noise component included in a captured image and reducing the undesirable component more accurately, and a control method for controlling the image processing apparatus.

The present disclosure includes an image obtaining unit configured to obtain a plurality of viewpoint images, a detecting unit configured to detect a first undesirable component of the viewpoint images according to relative difference information that is a difference between the viewpoint images, a noise information obtaining unit configured to obtain the noise information of the viewpoint images, a calculation unit configured to calculate a second undesirable component by subtracting noise from the first undesirable component with the first undesirable component and the noise information, and a reducing unit configured to reduce the second undesirable component of an image formed based on the viewpoint images.

Further features of the present disclosure will become apparent from the following description of exemplary embodiments (with reference to the attached drawings).

### BRIEF DESCRIPTION OF THE DRAWINGS

FIGS. 1A and 1B are block diagrams of an image processing apparatus according to one or more aspects of the present disclosure.

FIGS. 2A and 2B are diagrams of the relationship between an image capture element and a pupil of an optical system in the image capturing system according to one or more aspects of the present disclosure.

FIGS. 3A to 3C are explanatory diagrams of the structure of the optical system of the image capturing system and an undesirable light generated in the optical system according to one or more aspects of the present disclosure.

FIGS. 4A to 4E are conceptual diagrams of an image in each procedure of a ghost reduction process according to one or more aspects of the present disclosure.

FIGS. 5A and 5B are conceptual diagrams of an image before and after being processed in the ghost reduction process according to one or more aspects of the present disclosure.

FIG. 6 is a flowchart of image processing according to one or more aspects of the present disclosure.

FIG. 7 is a flowchart of a process for removing a noise component according to one or more aspects of the present disclosure.

FIG. 8 is a block diagram of an image processing unit according to one or more aspects of the present disclosure.

FIG. 9 is a flowchart of an image processing method according to one or more aspects of the present disclosure.

### DESCRIPTION OF THE EMBODIMENTS

Preferred embodiments of the present disclosure will be described in detail with reference to the appended drawings.

### First Exemplary Embodiment

An image capture apparatus used in the present exemplary embodiment is capable of generating a plurality of viewpoint images. The image capture apparatus includes an image capturing system that guides a plurality of amounts of luminance flux, which has passed through different regions of the pupil of the optical system, to different light-receiving units (pixels) in the image capture element so as to photoelectrically convert the amounts of luminance flux.

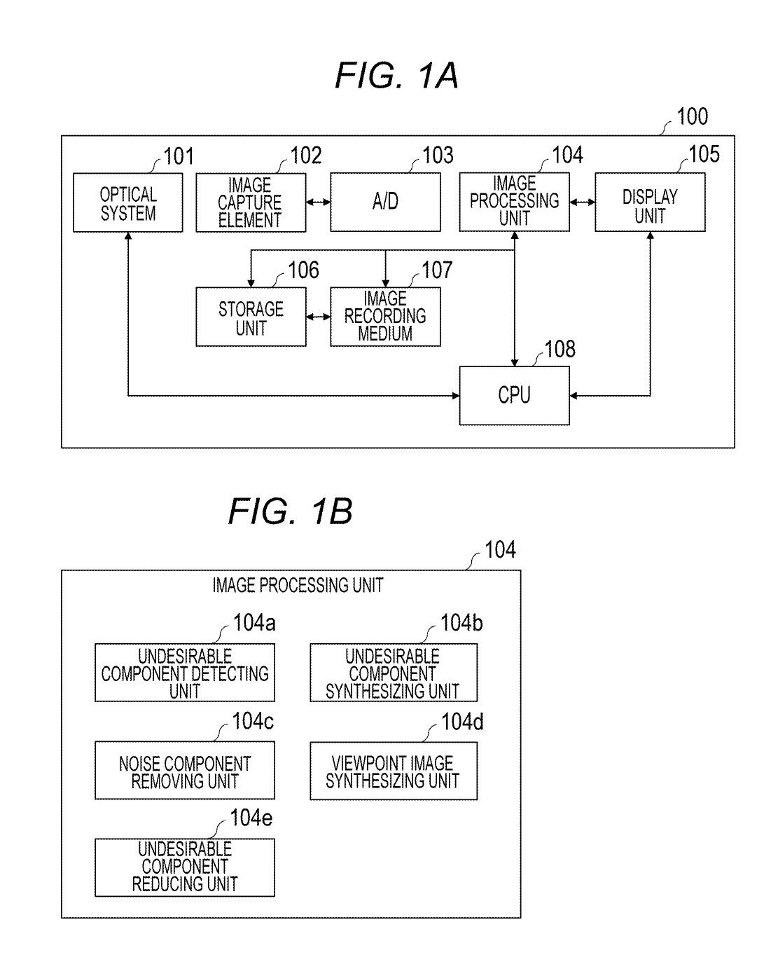

FIG. 1A is a block diagram of the configuration of an image capture apparatus 100 of an image processing apparatus according to the present exemplary embodiment. An optical system 101 focuses (collects) the luminance flux from an object (not illustrated) on an image capture element 102. The image capture element 102 includes a photoelectric conversion device such as a Charge Coupled Device (CCD) sensor or a Complementary Metal Oxide Semiconductor (CMOS) sensor. In the present exemplary embodiment, the luminance flux from different exit pupils (pupil regions) of the optical system is received with the pixel corresponding to each region. As described above, the image capture element 102 photoelectrically converts the object image (the optical image) and outputs image signals (analog electrical signals) of the viewpoint images. An A/D converter 103 converts the analog electrical signals output from the image capture element 102 into digital signals and outputs the digital signals to an image processing unit 104.

The image processing unit 104 performs all the image processing procedures of the input image data. The image processing unit 104 performs, for example, a demosaicing process, a process for correcting an inherent defect in the image capture element 102, a shading correction process, a process, for example, for correcting the black level, white balance processing, a gamma correction process, and a color conversion process. In addition, the image processing unit 104 performs, for example, a noise reduction process, and a compression and coding process. Furthermore, in order to suppress the effect of a ghost included in an image, the image processing unit 104 of the present exemplary embodiment processes the input image data in a correction process as described below so as to detect the included ghost based on the difference between a plurality of viewpoint images and reduce the effect of the ghost.

The output image (image data) processed by the image processing unit 104 is stored in an image recording medium 107 such as a semiconductor memory or an optical disk. In addition, the image output from the image processing unit 104 may be displayed on a display unit 105. A storage unit 106 stores an image processing program necessary for the image processing by the image processing unit 104 and various types of information.

A CPU 108 (control unit) performs various controls including a drive control of the image capture element 102, a control of the process by the image processing unit 104, and a drive control of the optical system 101. Note that the optical system 101 of the present exemplary embodiment is included in (integrated into) the image capture apparatus 100 including the image capture element 102 as a part of the image capture apparatus 100. The structure of the image capture apparatus 100 is not limited to the present exemplary embodiment. The image capture apparatus 100 can be an image capturing system such as a single-lens reflection camera in which an interchangeable optical system (exchangeable lens) is detachably attached to the main body of the image capture apparatus.

FIG. 1B is a block diagram of the configuration of the image processing unit 104 of the present exemplary embodiment. One or more of the functional blocks illustrated in FIG. 1B may be implemented with hardware such as an ASIC or a programmable logic array (PLA), or by executing software with a programmable processor such as a CPU or an MPU. Alternatively, the functional blocks may be implemented by the combination of software and hardware. Accordingly, the different functional blocks may be implemented with the same hardware even if the functional blocks will be described as different units below.

The image processing unit 104 processes the digital data in general image processing, and also performs a process for determining the undesirable light and a correction process for reducing or removing the undesirable light. The image processing unit 104 includes an undesirable component detecting unit 104a, an undesirable component synthesizing unit 104b, a noise component removing unit 104c, a viewpoint image synthesizing unit 104d, and an undesirable component reducing unit 104e.

The undesirable component detecting unit 104a generates (obtains) a viewpoint image and detects (determines) an undesirable component (a first undesirable component) of the viewpoint image. The undesirable component synthesizing unit 104b calculates a first composite value of the undesirable components detected by the undesirable component detecting unit 104a. The noise component removing unit 104c calculates a second composite value of the undesirable components by removing a noise component from the first composite value of the undesirable components calculated by the undesirable component synthesizing unit 104b. The viewpoint image synthesizing unit 104d synthesizes the viewpoint images generated by the undesirable component detecting unit 104a. The undesirable component reducing unit 104e reduces an undesirable component (a second undesirable component) of the viewpoint image synthesized by the viewpoint image synthesizing unit 104d based on the second composite value of the undesirable components that are the first undesirable components from which the noise components has been removed in the calculation by the noise component removing unit 104c. In the present exemplary embodiment, the second undesirable components are a value equal to the first composite value of the first undesirable components, or a value obtained based on the first composite value of the first undesirable components.

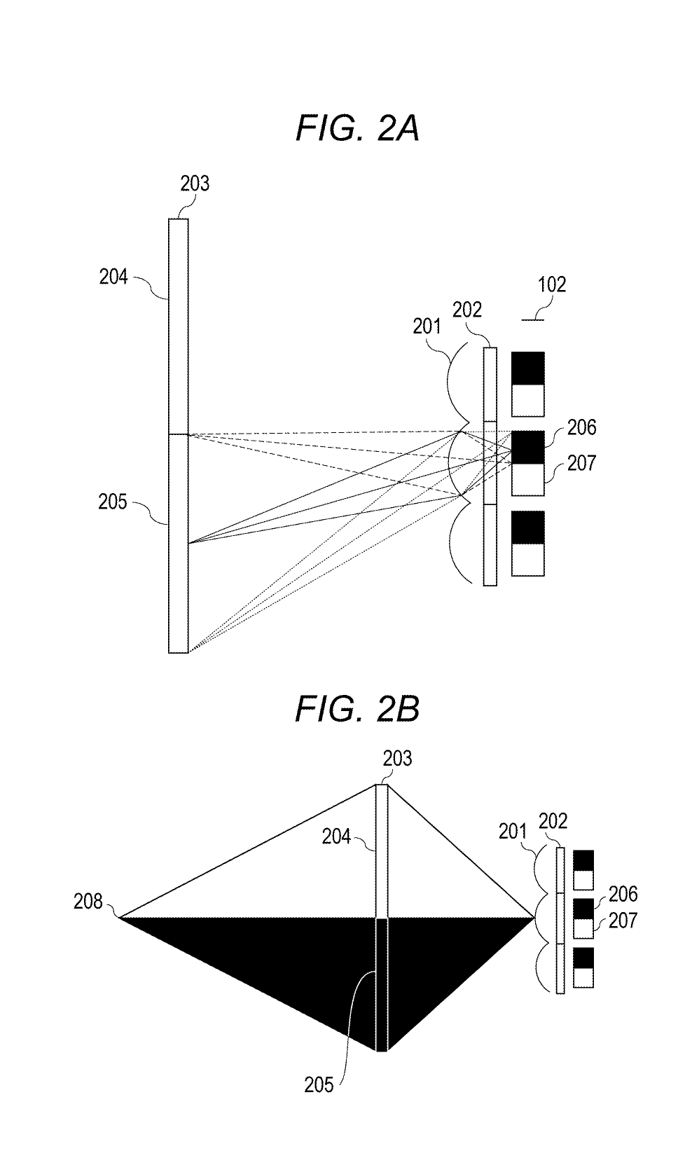

FIG. 2A is a diagram of the relationship between the light-receiving unit of the image capture element and the pupil of the optical system in the image capturing system of the present exemplary embodiment. A plurality of micro lenses 201 is arranged. Each of the micro lenses guides luminance flux to each photoelectric conversion device of the image capture element 102 including a color filter 202. The pixels of the image capture element 102 are arranged in a Bayer array in the present exemplary embodiment. However, the pixel arrangement is not limited to the Bayer array. An exit pupil 203 that is an exit pupil (pupil) of the optical system 101 is divided into a plurality of pupil regions 204 and 205.

A plurality of pairs of a pixel 206 and a pixel 207 is arranged in the image capture element 102. A pair of the pixel 206 and the pixel 207 has a conjugate relationship with the exit pupil 203 through a common micro lens 201 (in other words, a micro lens 201 provided for each pair of pixels). In each exemplary embodiment, the pixels 206 and the pixels 207 arranged in the image capture element are sometimes collectively referred to as a pixel group 206 and 207.

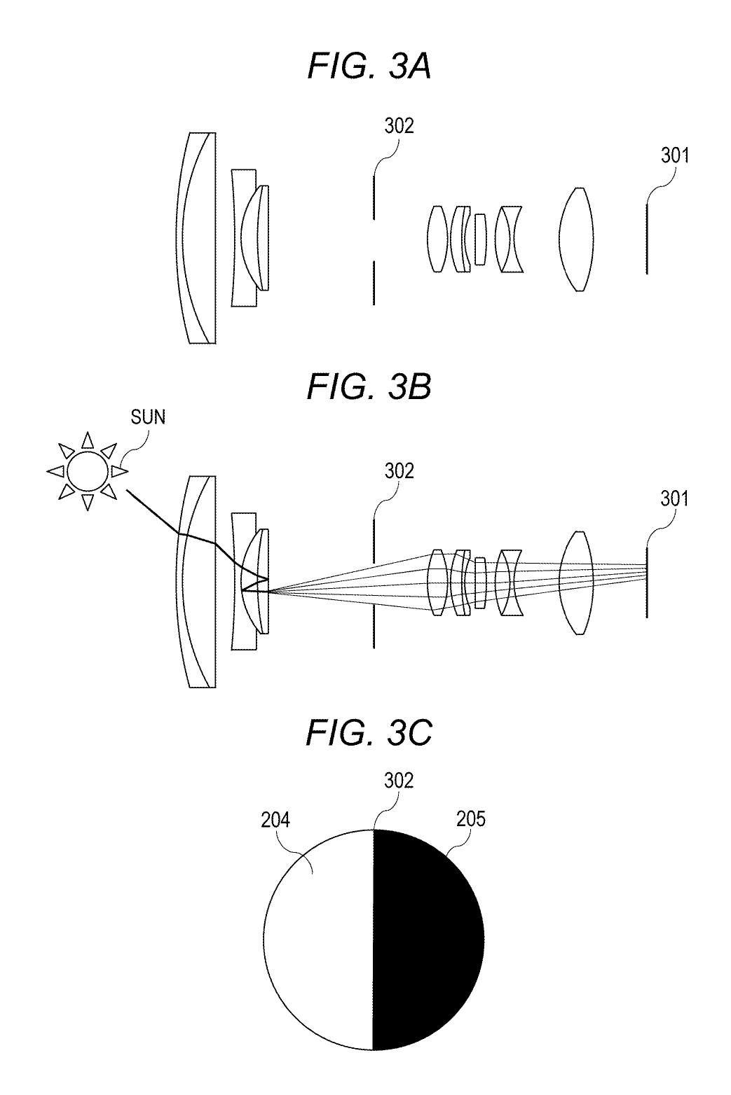

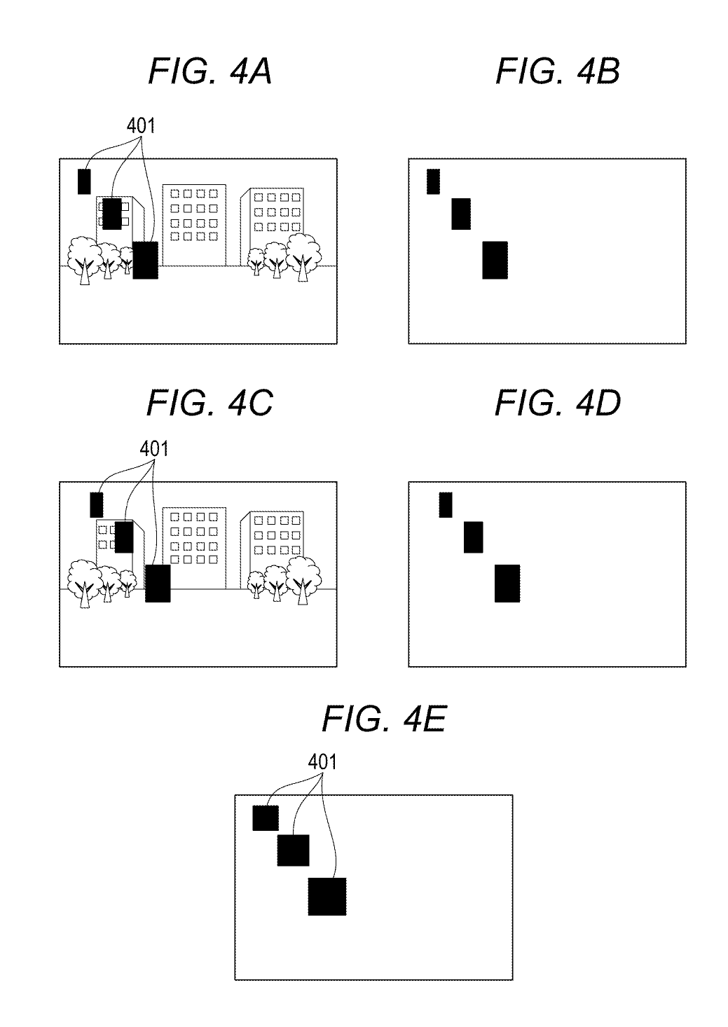

FIG. 2B is a schematic diagram of the image capturing system of the present exemplary embodiment. FIG. 2B illustrates an image capturing system on the assumption that a thin lens is provided instead of the micro lenses 201 illustrated in FIG. 2A at the position of the exit pupil 203. The pixel 206 receives the luminance flux passing through a region P1 of the exit pupil 203. The pixel 207 receives the luminance flux passing through a region P2 of the exit pupil 203. An object does not necessarily exist on an object point 208. The luminance flux passing through the object point 208 enters the pixel 206 or the pixel 207 according to the position through which the luminance flux passes (a region 204 or a region 205 in the present exemplary embodiment) in the pupil (the exit pupil 203). The luminance flux passes through different regions of the pupil. This means that the incident light from the object point 208 is separated according to the angle (parallax). In other words, a pair of pixels 206 and 207 provided for each of the micro lenses 201 provides a plurality (in this embodiment, a pair) of viewpoint images from different viewpoints. One of the viewpoint images is generated with the signal output from the pixel 206. The other is generated with the signal output from the pixel 207. A case in which the luminance flux passing through different regions of the pupil is received with different light-receiving units (pixels) will sometimes be referred to as pupil division. A case in which the misalignment of the exit pupil 203 illustrated in FIGS. 3A to 3C and FIGS. 4A to 4E makes the conjugate relationship incomplete or a case in which the regions 204 and 205 partially overlap may be considered. In such cases, the images provided in each exemplary embodiment are also treated as viewpoint images.

FIGS. 3A to 3C are explanatory diagrams of the structure of the optical system 101 and an undesirable light generated in the optical system 101. FIG. 3A illustrates a specific example of the structure of the optical system 101. In FIG. 3A, 302 is an aperture and 301 is an image pickup plane. The image capture element 102 illustrated in FIG. 1A is located at the position of the image pickup plane 301. FIG. 3B illustrates that a strong light of the sun SUN that is an exemplary object with high luminance enters the optical system 101, and the light is reflected on the boundary face of a lens included in the optical system 101 and reaches the image pickup plane 301 as an undesirable light (a ghost or flare).

FIG. 3C illustrates the regions P1 and P2 (the pupil regions or the pupil-divided regions) of the aperture 302 through which the luminance flux that is to enter the pixels 206 and 207 illustrated in FIGS. 4A to 4E passes. Note that the aperture 302 may correspond to the exit pupil 203 of the optical system 101. Actually, the aperture 302 is often different from the exit pupil 203. The luminance flux from the high-luminance object (the sun SUN) passes through almost all the regions of the aperture 302, and the region through which the luminance flux that is to enter the pixels 206 and 207 passes is divided into the regions 204 and 205 (the pupil regions).

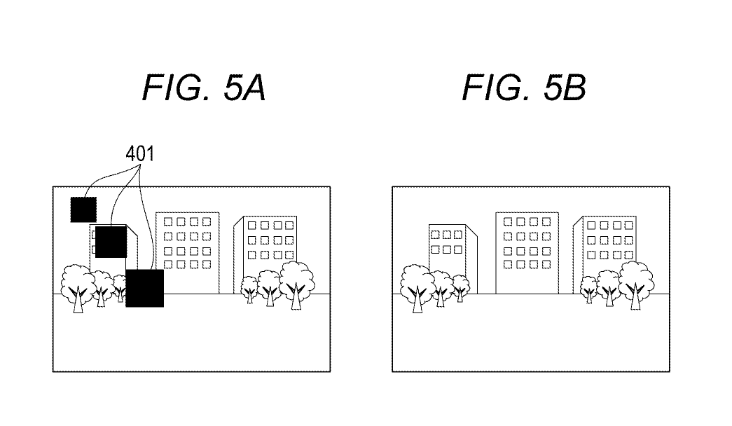

Next, a method for determining an undesirable component will be described with reference to FIGS. 4A to 4E and FIGS. 5A and 5B. The undesirable component is an image component appearing in an image captured by the image capture apparatus 100 when the image capture apparatus 100 photoelectrically converts the undesirable light.

FIGS. 4A to 4E illustrate the procedures of an image processing method of the present exemplary embodiment. FIGS. 5A and 5B illustrate an exemplary image output by the image processing method of the present exemplary embodiment.

FIG. 5A illustrates a captured image that is the composite image of a plurality of viewpoint images generated by the image capture with the pupil division. The captured image includes constructions such as buildings and trees around the constructions as objects. Black rectangles GST in the captured image of FIG. 5A are the undesirable components (ghost components) that are image components of an undesirable light (a ghost). Note that the undesirable components GST are filled with black in FIG. 5A. The actual objects, however, are seen through the undesirable components GST to a degree. In addition, the undesirable component is the undesirable light covering the captured object. Thus, the undesirable component has luminance higher than the captured object.

FIGS. 4A and 4C illustrate a pair of viewpoint images that are the results of photoelectrically converting the luminance flux passing through the regions p1 and p2 (the pupil regions) with the pixel groups 206 and 207, respectively. When a pair of viewpoint images captures a short-range object, there is a difference corresponding to the parallax between the image components of the viewpoint images (an object parallax component). When a pair of viewpoint images captures a long-range object in a landscape as illustrated in FIGS. 4A to 4E, there is a very small number of object parallax components. In addition, the pair of the viewpoint images includes the undesirable components gst schematically illustrated as black rectangles. The undesirable components gst are located at different positions depending on the images. FIGS. 4A to 4E illustrate examples in which the undesirable components gst are separate each other without overlapping. However, the undesirable components gst may overlap and have different luminance levels. In other words, black rectangular undesirable components gst need to be located at different positions and have different luminance levels.

FIG. 4B illustrates an image (a relative difference image) of the pair of viewpoint images obtained by subtracting the image of FIG. 4C from the image of FIG. 4A that is a reference image. The image (relative difference image) of FIG. 4B includes the object parallax components and the undesirable components as the difference (the relative difference information) of the pair of viewpoint images. The images illustrated in FIGS. 4A to 4E capture a long-range object in a landscape. Thus, there are a very small number of object parallax components between the images and the effect of the object parallax components may largely be ignored. The undesirable components included in FIG. 4C are calculated as a negative number in the subtraction described above. To simplify the undesirable component reduction process to be described below, the negative number is not included in the image in FIG. 4B. Thus, FIG. 4B illustrates that the image (the relative difference image) only depicting the undesirable components included in FIG. 4A.

Similarly, FIG. 4D illustrates an image obtained by subtracting the image of FIG. 4A from the image that is a reference image of FIG. 4E of the pair of viewpoint images. Similarly to the image of FIG. 4B, the undesirable components included in FIG. 4A are calculated as a negative number in the subtraction described above. To simplify the undesirable component reduction process to be described below, the negative number is not included in the image in FIG. 4D. Thus, FIG. 4D illustrates that the image (the relative difference image) only depicting the undesirable components included in FIG. 4E. As described above, the image processing method of the present exemplary embodiment can determine the undesirable components by the process for making only the undesirable components of the relative difference image remain (in other words, by the process for separating or extracting the undesirable components).

Here, a case in which a captured image as illustrated in FIG. 5A that is an image obtained by combining (synthesizing) a plurality of viewpoint images generated by the pupil division is output will be considered. In this case, the undesirable components are extracted from each of the viewpoint images as described above. Subtracting the undesirable components extracted from each of the viewpoint images from the undesirable components of the combined image in order to reduce the undesirable components of the combined image can be considered as a method. However, this method requires to perform the undesirable component reduction process as many times as the number of the viewpoint images while a composite image of the viewpoint images is output. This complicates the reduction process.

In light of the foregoing, a synthesis process for synthesizing the undesirable components of the viewpoint images is performed when a composite image of viewpoint images is output in the present exemplary embodiment, similarly to the synthesis process for synthesizing the viewpoint images of the output images. In order to output an image obtained by combining (synthesizing) the viewpoint images as a final output image, the undesirable components of the viewpoint images are combined (synthesized) in the present exemplary embodiment. FIG. 4E illustrates the combined (synthesized) undesirable components. When the combined value (the composite value) of the viewpoint images is output as an output image, the undesirable components included in the output image have a value identical to the combined value (the composite value) of the undesirable components included in the viewpoint images.

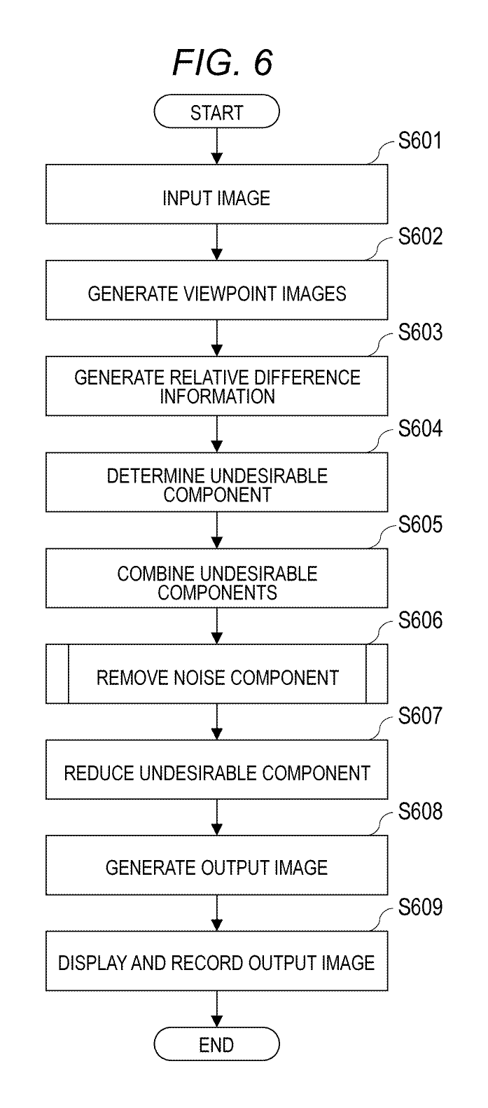

Next, the procedures of a determination process (image processing) for determining a undesirable component (a ghost component) in the present exemplary embodiment will be described with reference to FIG. 6. FIG. 6 is a flowchart describing an image processing method (an undesirable component determination method) in the present exemplary embodiment. Each procedure in FIG. 6 is executed mainly by the CPU 108 or the image processing unit 104 according to an image processing program that is a computer program. Alternatively, each procedure in FIG. 6 is executed by each unit according to the instructions from the CPU 108 or the image processing unit 104. The flow of the procedures starts, for example, when the image capture element 102 captures an image (for example, in a mode in which images are sequentially captured and digital signals of the captured images are output, or when the images are recorded just after being captured), or when image data is read from a memory to a temporary memory area in the image processing unit 104.

First, in step S601, the CPU 108 controls an image capture unit including the optical system 101, the image capture element 102, and the A/D converter 103 (the image capture system) to capture an image of an object and obtains the input image (the captured image). Alternatively, the CPU 108 reads the image data previously captured and recorded in the image recording medium 107 into the temporary memory area of the image processing unit 104 to obtain an input image. The images obtained as the input images in the present exemplary embodiment include a composite image of a plurality of viewpoint images corresponding to the luminance flux passing through the different pupil regions of the optical system 101 in the image capture element 102, and the viewpoint images that are not synthesized yet and correspond to some of the pupil regions. The input images are not limited to the present exemplary embodiment. Each of viewpoint images may be obtained as an input image.

In step S602, the CPU 108 controls the image processing unit 104 to generate a pair of viewpoint images that are the composite image and one of the viewpoint images. Specifically, taking a difference can calculate a plurality of viewpoint images. Here, the image processing unit 104 can perform some of the various types of image processing described above while generating the viewpoint images. When a plurality of viewpoint images is obtained as input images in step S601, only some of the various types of image processing need to be performed in step S602.

Next, in step S603, the undesirable component detecting unit 104a of the image processing unit 104 calculates the relative difference information between the viewpoint images of the pair. In other words, the undesirable component detecting unit 104a generates a relative difference image (the image of FIG. 4B) of which reference image is the image of FIG. 4A, and a relative difference image (the image of FIG. 4D) of which reference image is the image of FIG. 4C. When the undesirable light reaching the image pickup plane passes through the different pupil regions of the pupil (the exit pupil) in the optical system 101, the undesirable components are generated at different positions depending on the viewpoint images as illustrated in FIG. 4A and FIG. 4C. Thus, a simple relative difference image takes a positive and a negative number as the difference values of the undesirable components. For example, the image of FIG. 4C is subtracted from the image of FIG. 4A that is the reference image when the relative difference image (the image of FIG. 4B) is generated, the undesirable components included in the image of FIG. 4A is a positive number in the present exemplary embodiment. On the other hand, the undesirable components included in the image of FIG. 4C is a negative number.

At that point in the present exemplary embodiment, the undesirable component detecting unit 104a performs a process for removing the negative number and putting a zero value instead in order to simplify the undesirable component reduction process to be described below. Thus, only the undesirable components included in FIG. 4A is detected as the positive number in the image of FIG. 4B. The undesirable component detecting unit 104a similarly processes the relative difference image (the image of FIG. 4D). Thus, only the undesirable components included in FIG. 4C is detected as the positive number in the image of FIG. 4D.

Alternatively, in order to remove the object parallax component when the relative difference information between the images capturing a short-range object is calculated, the undesirable component detecting unit 104a can align the positions of the viewpoint images of the pair. Specifically, the undesirable component detecting unit 104a can align the positions of the viewpoint images of the pair by shifting a first viewpoint image of the pair relatively to a second viewpoint image of the pair and determining the shift position of the first viewpoint image at which the correlation between the first and second viewpoint images is maximized. Alternatively, the undesirable component detecting unit 104a can align the positions of the first and second viewpoint images by determining the shift position at which the square sum of the difference between the first and second viewpoint images is minimized. Alternatively, the undesirable component detecting unit 104a can shift an in-focus area in a first viewpoint image of the pair and determine the shift position of the in-focus area to align the first and second viewpoint images of the pair.

Alternatively, the undesirable component detecting unit 104a can detect the edges of each of the viewpoint images to determine a shift position to be shifted in order to align the viewpoint images, according to the detected edges. This edge detection method detects a high-contrast edge of an in-focus area. There is a low contrast in an area that is not in focus such as a background and this low contrast makes it difficult to detect the area that is not in focus as an edge. Thus, the undesirable component detecting unit 104a determines the shift position necessarily focusing on the in-focus area. Furthermore, the undesirable component detecting unit 104a can perform an additional procedure, for example, a threshold process for removing the effect of the noise when generating a relative difference image.

Next, in step S604, the undesirable component detecting unit 104a determines the components remaining in the relative difference images generated in step S603 as the undesirable components.

Next, in step S605, the undesirable component synthesizing unit 104b of the image processing unit 104 performs a process for combining the undesirable components of the viewpoint images determined in step S604 (calculates the composite value of the undesirable components). Specifically, the undesirable component synthesizing unit 104b performs a process for adding the relative difference image of FIG. 4B and the relative difference image of FIG. 4D (calculates the composite value of the relative difference images). As a result, the combined (synthesized) undesirable components illustrated in FIG. 4E are generated.

Next, in step S606, the noise component removing unit 104c of the image processing unit 104 performs a correction process for reducing or removing the noise component from the undesirable components. Specifically, the noise component removing unit 104c performs a process for subtracting the noise included in the undesirable components included in the viewpoint images from the composite value of the undesirable components calculated in step S605.

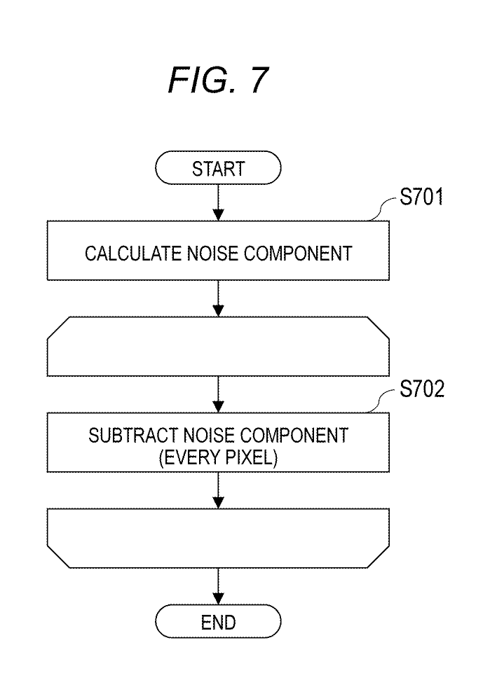

Hereinafter, the procedures of the correction process for reducing or removing the noise component in the present exemplary embodiment will be described with reference to FIG. 7.

In step S701, the noise component removing unit 104c calculates the noise component according to the standard deviation of the noise components (the noise information) previously measured in the image capture element 102 and stored in the storage unit 106. The predicted values of the noise components are measured from the results of previously capturing an object with a uniform intensity of luminance with the image capture element 102 and sorted according to the ISO sensitivity largely affecting the noise in a table. Actually measuring the noise components of each of viewpoint images takes time and effort, and the shading of the viewpoint image affects the actual measurement. In light of the foregoing, the present exemplary embodiment determines the noise components from the measurement data of the composite image of the viewpoint images corresponding to the luminance flux from the different pupil regions of the optical system. The noise components are determined based on the measured values and every pixel may have a uniform noise component according to the ISO sensitivity, according to the image height, or according to the pixel. In step S702, the noise components calculated in step S701 are subtracted from the composite value of the undesirable components calculated in step S605. The noise components included in the undesirable components of each viewpoint image are loaded every time the undesirable components are combined in step S605. Thus, the process for subtracting the noise components needs to be performed as many as the number of the viewpoint images minus one. The method of subtracting the noise components is not limited to the method in step S702. For example, the standard deviation of the noise components of each viewpoint image can be calculated. In this case, specifically, the image is divided into local regions of a 10 by 10 image. The standard deviation of the pixel values of each local region is calculated. Then, a process for subtracting the noise components is performed in each local region.

Next, in step S607, the undesirable component reducing unit 104e of the image processing unit 104 performs a correction process for reducing or removing the undesirable components from the image to be output. Specifically, the undesirable component reducing unit 104e subtracts the undesirable components calculated in step S605 and illustrated in FIG. 4E from the composite image obtained in step S601 and illustrated in FIG. 5A. When only a plurality of viewpoint images is obtained and a composite image is not obtained in step S601 in an exemplary embodiment, the undesirable components calculated in step S605 are subtracted from a composite image generated from the viewpoint images and this subtraction generates a correction image. In step S608, the correction image is processed with a process that the image processing unit 104 normally performs. This process generates an output image to be output to the image recording medium 107 or the display unit 105. At the same time, the correction image is processed in a publicly known noise reduction process in addition to a normal development process including a white balance process or a gamma correction. This process reduces the noise of the correction image.

At last, in step S609, the CPU 108 records the output image illustrated in FIG. 5B from which the undesirable components have been removed or reduced in the image recording medium 107. Alternatively or additionally, the CPU 108 displays the output image on the display unit 105. Then, the process is completed.

As described above, the present exemplary embodiment improves a reduction process for reducing the undesirable components of an image by reducing or removing a noise component from the undesirable components using the image processing apparatus that reduces the undesirable components caused by a undesirable light in an image formed based on a plurality of viewpoint images.

In the present exemplary embodiment, a composite image that have been obtained by analog synthesis in an image capture sensor when the composite image is output from the sensor or a composite image of a plurality of viewpoint images has been described as an example of an image formed based on a plurality of viewpoint images that is an image to be processed in a ghost reduction process. However, the image to be processed is not limited to the examples. For example, the undesirable components of one of the viewpoint images may be calculated as the undesirable components calculated in the present exemplary embodiment. The undesirable components of one of the viewpoint images may be used for the reduction process.

### Second Exemplary Embodiment

Next, a second exemplary embodiment of the present disclosure will be described. In the first exemplary embodiment, the noise component is subtracted from the undesirable components calculated from a plurality of viewpoint images. On the other hand, in the present exemplary embodiment, the noise component is subtracted from each of the viewpoint images, and then the undesirable components of the viewpoint images are calculated. Thus, the undesirable components from which the noise component has been reduced or removed are calculated.

The basic configuration of the image capture apparatus of the present exemplary embodiment is similar to the image capture apparatus 100 of the first exemplary embodiment described with reference to FIG. 1A, and thus the descriptions will be omitted.

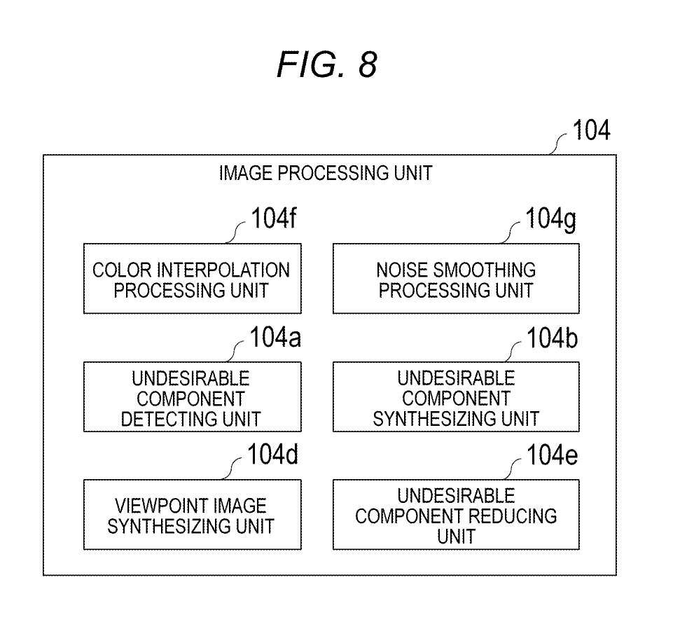

FIG. 8 is a block diagram of the configuration of an image processing unit 104 of the present exemplary embodiment. The processing units of the image processing unit 104 and processes performed by the image processing unit 104 that are not illustrated in the block diagram are similar to those of the image processing unit 104 of the first exemplary embodiment described with reference to FIG. 1B. In the present exemplary embodiment, the image processing unit 104 includes a color interpolation processing unit 104f, a noise smoothing processing unit 104g, an undesirable component detecting unit 104a, an undesirable component synthesizing unit 104b, a viewpoint image synthesizing unit 104d, and an undesirable component reducing unit 104e.

The color interpolation processing unit 104f performs a demosaicing process included in the general image processing described above. In the present exemplary embodiment, the image capture element 102 is a sensor including color filters arranged in a Bayer array. Interpolating the color mosaic image data of the two colors absent in each pixel among three primary colors generates a color demosaiced image that has all the R, G, and B color image data of every pixel.

The noise smoothing processing unit 104g obtains the demosaiced image generated in the color interpolation processing unit 104f to reduce the noise of the demosaiced image (smooth the demosaiced image).

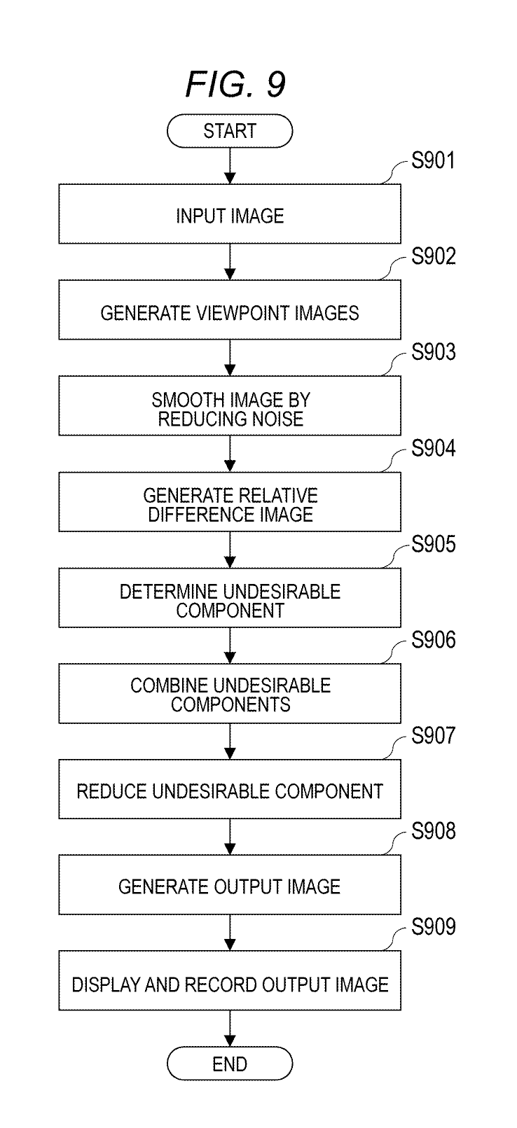

Next, the procedures of a determination process (image processing) for determining an undesirable component (a ghost component) in the present exemplary embodiment will be described with reference to FIG. 9. FIG. 9 is a flowchart describing an image processing method in the present exemplary embodiment. Each procedure in FIG. 9 is executed mainly by the CPU 108 or the image processing unit 104 according to an image processing program that is a computer program. Alternatively, each procedure in FIG. 9 is executed by each unit according to the instructions from the CPU 108 or the image processing unit 104. The flow of the procedures starts, for example, when the image capture element 102 captures an image (for example, in a mode in which images are sequentially captured and digital signals of the captured images are output, or when the images are recorded just after being captured), or when image data is read from a memory to a temporary memory area in the image processing unit 104.

First, in step S901, the CPU 108 controls an image capture unit including the optical system 101, the image capture element 102, and the A/D converter 103 (the image capture system) to capture an image of an object and obtains the input image (the captured image). Alternatively, the CPU 108 reads the image data previously captured and recorded in the image recording medium 107 into the temporary memory area of the image processing unit 104 to obtain an input image. The images obtained as the input images in the present exemplary embodiment include a composite image of a plurality of viewpoint images corresponding to the luminance flux passing through the different pupil regions of the optical system 101 in the image capture element 102, and the viewpoint images that are not synthesized yet and correspond to some of the pupil regions. The input images are not limited to the present exemplary embodiment. Each of viewpoint images may be obtained as an input image.

In step S902, the CPU 108 controls the image processing unit 104 to generate a pair of viewpoint images that are the composite image and one of the viewpoint images. Specifically, taking a difference can calculate a plurality of viewpoint images. Here, the image processing unit 104 can perform some of the various types of image processing described above while generating the viewpoint images. When a plurality of viewpoint images is obtained as input images in step S901, only some of the various types of image processing need to be performed in step S902. Furthermore, in step S902, the CPU 108 generates the demosaiced image by controlling the image processing unit 104. The color interpolation processing unit 104f of the image processing unit 104 generates the demosaiced image having all the R, G, and B color image data by interpolating the mosaic image data.

In step S903, the noise smoothing processing unit 104g performs a correction process for smoothing or reducing the noise components of the viewpoint images generated in step S902. Specifically, the noise smoothing processing unit 104g processes at least a pixel in a region, which is to be processed with the ghost reduction process, in a filtering process. For example, the noise smoothing processing unit 104g performs a process for replacing the value of each pixel with the median of the pixels around the pixel using a five by five median filter.

Next, in step S904, the undesirable component detecting unit 104a of the image processing unit 104 calculates the relative difference information between a pair of viewpoint images generated after the noise reduction process in step S903. In other words, the undesirable component detecting unit 104a generates a relative difference image (the image of FIG. 4B) of which reference image is the image of FIG. 4A, and a relative difference image (the image of FIG. 4D) of which reference image is the image of FIG. 4C. When the undesirable light reaching the image pickup plane passes through the different pupil regions of the pupil (the exit pupil) in the optical system 101, the undesirable components are generated at different positions depending on the viewpoint images as illustrated in FIG. 4A and FIG. 4C. Thus, a simple relative difference image takes a positive and a negative number as the difference values of the undesirable components. For example, the image of FIG. 4C is subtracted from the image of FIG. 4A that is the reference image when the relative difference image (the image of FIG. 4B) is generated, the undesirable components included in the image of FIG. 4A is a positive number in the present exemplary embodiment. On the other hand, the undesirable components included in the image of FIG. 4C is a negative number.

Next, in step S905, the undesirable component detecting unit 104a determines the components remaining in the relative difference images generated in step S904 as the undesirable components.

In step S906, the undesirable component synthesizing unit 104b of the image processing unit 104 performs a process for combining the undesirable components of the viewpoint images determined in step S905 (calculates the composite value of the undesirable components). Specifically, the undesirable component synthesizing unit 104b performs a process for adding the relative difference image of FIG. 4B and the relative difference image of FIG. 4D (calculates the composite value of the relative difference image). As a result, the combined (synthesized) undesirable component illustrated in FIG. 4C is generated.

Next, in step S907, the undesirable component reducing unit 104e of the image processing unit 104 performs a correction process for reducing or removing the undesirable components from the image to be output. Specifically, the undesirable component reducing unit 104e subtracts the undesirable components calculated in step S905 and illustrated in FIG. 4E from the composite image obtained in step S901 and illustrated in FIG. 5A. When only a plurality of viewpoint images is obtained and a composite image is not obtained in step S901 in an exemplary embodiment, the undesirable components calculated in step S905 are subtracted from a composite image generated from the viewpoint images and this subtraction generates a correction image.

In step S908, the correction image is processed with a process that the image processing unit 104 normally performs. This process generates an output image to be output to the image recording medium 107 or the display unit 105. At the same time, the correction image is processed in a publicly known noise reduction process in addition to a normal development process including a white balance process or a gamma correction. This process reduces the noise of the correction image.

At last, in step S909, the CPU 108 records the output image illustrated in FIG. 5B from which the undesirable components have been removed or reduced in the image recording medium 107. Alternatively or additionally, the CPU 108 displays the output image on the display unit 105. Then, the process is completed.

The present exemplary embodiment improves a reduction process for reducing the undesirable components of an image by reducing or removing a noise component from the undesirable components using the image processing apparatus that reduces the undesirable components caused by a undesirable light in an image formed based on a plurality of viewpoint images.

### (Another Exemplary Embodiment)

The objective of the present disclosure may be achieved as described below. In other words, a storage medium in which a program code of software describing the procedures for implementing the functions described in each embodiment is recorded is provided to a system or an apparatus. Then, a computer (or, a CPU or an MPU) of the system or apparatus reads and executes the program code stored in the storage medium.

In such a case, the program code read from the storage medium implements a new function of the present disclosure, and the storage medium storing the program code and the program are included in the present disclosure.

The storage medium to provide the program code may, for example, be a flexible disk, a hard disk, an optical disk, or a magnet-optical disk. Alternatively, a CD-ROM, a CD-R, a CD-RW, a DVD-ROM, a DVD-RAM, a DVD-RW, a DVD-R, a magnetic tape, a non-volatile memory card, a ROM, or the like may be used as the storage medium.

Alternatively, making the program code read by the computer executable implements the functions described in each embodiment. Furthermore, for example, an operating system (OS) running on the computer performs some or all of the actual processes according to the commands in the program code, and the actual processes may implement the functions described in each embodiment.

In addition, the following case is included in the disclosure. First, the program code read from a storage medium is written into a memory included in a function extension board inserted in the computer or a function extension unit connected to the computer. After that, for example, a CPU included in the function extension board or the function extension unit performs some or all of the actual processes.

The present disclosure may be applied not only to a device mainly for image sensing such as a digital camera but also to an arbitrary apparatus including a built-in or externally-connected image capture apparatus such as a mobile phone, a personal computer (for example, a laptop, a desktop, or a tablet), or a game console. Thus, the “image capture apparatus” described herein is intended for including an arbitrary electric appliance with an image capturing function.

The present disclosure can reduce the undesirable components of a captured image more accurately by suppressing the noise component included in the captured image.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, the scope of the following claims are to be accorded the broadest interpretation so as to encompass all such modifications and equivalent structures and functions.

This application claims the benefit of Japanese Patent Application No. 2016-143696, filed Jul. 21, 2016, which is hereby incorporated by reference herein in its entirety.

What is claimed is:

1. An image processing apparatus comprising:
one or more processors; and
a memory storing instructions which, when executed by the one or more processors, cause the image processing apparatus to function as:
a first obtaining unit configured to obtain a plurality of viewpoint images;
a detecting unit configured to detect a first undesirable component of the viewpoint images according to relative difference information that is a difference between the viewpoint images;
a second obtaining unit configured to obtain noise information of the viewpoint images;
a calculation unit configured to calculate a second undesirable component by subtracting noise from the first undesirable component according to the first undesirable component and the noise information; and
a reducing unit configured to reduce the second undesirable component of an image formed based on the viewpoint images.

2. The image processing apparatus according to claim 1, wherein the reducing unit reduces the second undesirable component of a composite image of the viewpoint images.

3. The image processing apparatus according to claim 2, wherein the detecting unit detects the first undesirable component of each of the viewpoint images and calculates a composite value of the first undesirable components of the viewpoint images.

4. The image processing apparatus according to claim 1, wherein the noise information is calculated based on undesirable components of the viewpoint images previously captured and measured by an image capture element.

5. The image processing apparatus according to claim 1, further comprising:
an image processing unit configured to perform a noise reduction process for reducing noise of the image processed by the reducing unit.

6. The image processing apparatus according to claim 5, wherein the image processing unit performs image processing including a demosaicing process in addition to the noise reduction process.

7. The image processing apparatus according to claim 1, wherein the viewpoint image is divided into a plurality of regions, and the noise information is calculated based on a standard deviation of the regions.

8. The image processing apparatus according to claim 1, wherein the noise information is calculated based on a standard deviation of undesirable components of the viewpoint images previously captured and measured by an image capture element.

9. An image processing apparatus comprising:
an obtaining unit configured to obtain a plurality of viewpoint images;
a reducing unit configured to reduce a noise component of each of the viewpoint images;
a detecting unit configured to detect an undesirable component of the viewpoint images according to relative difference information between the viewpoint images; and
a reducing unit configured to reduce the undesirable component of an image formed based on the viewpoint images.

10. The image processing apparatus according to claim 9, wherein the reducing unit reduces the undesirable component of a composite image of the viewpoint images.

11. The image processing apparatus according to claim 9, wherein the detecting unit detects the undesirable component of each of the viewpoint images and calculates a composite value of the undesirable components of the viewpoint images.

12. The image processing apparatus according to claim 9, further comprising:
an image processing unit configured to perform a noise reduction process for reducing noise of the image processed by the reducing unit.

13. The image processing apparatus according to claim 12, wherein the image processing unit performs image processing including a demosaicing process in addition to the noise reduction process.

14. A control method for controlling an image processing apparatus, the method comprising:
obtaining a plurality of viewpoint images;
detecting a first undesirable component of the viewpoint images according to relative difference information that is a difference between the viewpoint images;
obtaining noise information of the viewpoint images;
calculating a second undesirable component by subtracting noise from the first undesirable component according to the first undesirable component and the noise information; and
reducing the second undesirable component of an image formed based on the viewpoint images.

15. A control method for controlling an image processing apparatus, the method comprising:
obtaining a plurality of viewpoint images;
reducing a noise component of each of the viewpoint images;
detecting an undesirable component of the viewpoint images according to relative difference information between the viewpoint images; and
reducing the undesirable component of an image formed based on the viewpoint images.

16. A non-transitory computer readable storage medium storing a program for causing a computer to perform procedures of a control method for controlling an image processing apparatus, the procedures comprising:
obtaining a plurality of viewpoint images;
reducing a noise component of each of the viewpoint images;
detecting an undesirable component of the viewpoint images according to relative difference information between the viewpoint images; and
reducing the undesirable component of an image formed based on the viewpoint images.
